(19) United States
(12) Patent Application Publication
(10) Pub. No.: US 2017/0212626 A1
(43) Pub. Date: Jul. 27, 2017

(54) IN-CELL TOUCH SCREEN AND A DISPLAY DEVICE

(71) Applicant: BOE TECHNOLOGY GROUP CO., LTD., Beijing (CN)

(72) Inventor: Jiayang ZHAO, Beijing (CN)

(21) Appl. No.: 14/769,092

(22) PCT Filed: Feb. 15, 2015
(86) PCT No.: PCT/CN2015/073111

§ 371 Date: Aug. 19, 2015

(30) Foreign Application Priority Data
Oct. 13, 2014 (CN) 201410539187.2
Dec. 15, 2014 (CN) 201410779621.4

(51) Int. Cl. G06F 3/041; G06F 3/044

(52) U.S. Cl. CPC G06F 3/0416; G06F 3/0412; G06F 3/044; G06F 2203/04107

(57) ABSTRACT

The present invention discloses an in-cell touch screen, wherein a common electrode layer on the array substrate is multiplexed as self-capacitance electrodes. The common electrode layer comprises a plurality of self-capacitance electrodes arranged in array, and the common electrode layer is divided into a plurality of adjacent touch scanning areas, each touch scanning area comprises at least one row of self-capacitance electrodes. In this way, when the gate lines within one of the plurality of touch scanning areas are scanned row by row, the self-capacitance electrodes within the one touch scanning area are applied with common electrode signals, and the self-capacitance electrodes in other touch scanning areas of the plurality of touch scanning areas are applied with touch detection signals. That is to say, when display is performed in one touch scanning area, touch driving is performed in other touch scanning areas. By means of the above driving manner, the aim of simultaneous display and touch control can be achieved. It can be ensured that the various display problems and touch problems would not be caused by insufficient time due to time division driving when performing high resolution display. The present invention further discloses a display device comprising the above in-cell touch screen.

### FIELD OF THE INVENTION

The present invention relates to the field of display technology, particularly to an in-cell touch screen and a display device.

### BACKGROUND OF THE INVENTION

With the rapid development of the display technology, the touch screen has been popularized in people's life gradually. At present, the touch screen can be classified into add-on mode touch screen, on-cell touch screen, and in-cell touch screen according to the composition structure. In the add-on mode touch screen, the touch screen and the liquid crystal display (LCD) screen are produced separately, then jointed together to become a liquid crystal display screen with the touch function. The add-on mode touch screen has the shortcomings of high fabricating cost, low light transmittance, thick modules, etc. Whereas in the in-cell touch screen, the touch electrodes of the touch screen are embedded within the liquid crystal display screen, which can reduce the thickness of the whole module, and can also reduce the fabricating cost of the touch screen greatly, thus gains popularity among panel manufacturers.

At present, the existing in-cell touch screen makes use of the principle of mutual capacitance or self-capacitance to realize detection of the finger touch position. The pattern of the touch electrode is added in the touch screen generally. In order to avoid mutual interference between the touch signal applied by the touch electrode and the normal display signal in the touch screen, the touch function and the display function are generally driven time-divisionally. As shown in FIG. 1, i.e., the time of one frame (Vsync) is divided into touch time period (Touch) and display time period (Display). The data signal and the gate lines Gn-2, Gn-1, Gn, G1, G2 and G3 only work in the display time, and the touch signal only works on the touch time. Thus the time lengths allocated to the touch time period and the display time period in each frame are relatively short. When the high resolution display is required, various display problems and touch problems would be caused by insufficient time due to time-divisional driving.

### SUMMARY OF THE INVENTION

In view of this, the embodiment of the present invention provides an in-cell touch screen and a display device, for solving the various display problems and touch problems caused by insufficient time due to time-divisional driving of the touch function and the display function required by the existing in-cell touch screen.

Therefore, the embodiment of the present invention provides an in-cell touch screen, comprising: an array substrate having gate lines, data lines and a common electrode layer, wherein: the common electrode layer comprises a plurality of self-capacitance electrodes arranged in array; the common electrode layer is divided into a plurality of adjacent touch scanning areas, each touch scanning area comprises at least one row of self-capacitance electrodes; when the gate lines within one of the plurality of touch scanning areas are scanned row by row, the self-capacitance electrodes within the one touch scanning area are applied with common electrode signals, and the self-capacitance electrodes in other touch scanning areas of the plurality of touch scanning areas are applied with touch detection signals.

In a possible implementing mode, the above in-cell touch screen provided by the embodiment of the present invention further comprises: a touch detection chip arranged on the array substrate for determining the touch position by detecting variation of capacitance values of the self-capacitance electrodes; the touch detection chip is located at the left side or the right side of the array substrate; the self-capacitance electrodes within the plurality of touch scanning areas are connected with the touch detection chip through wiring respectively, the extending direction of the wiring is same as the extending direction of the gate lines.

In a possible implementing mode, in the above in-cell touch screen provided by the embodiment of the present invention, within the plurality of touch scanning areas, shielding electrodes located between the self-capacitance electrodes and the layer where the data lines locate are arranged, an orthogonal projection of the shielding electrodes on the array substrate shields an overlapping area of the self-capacitance electrodes and the data lines.

In a possible implementing mode, in the above in-cell touch screen provided by the embodiment of the present invention, the shielding electrodes are applied with DC signals.

In a possible implementing mode, in the above in-cell touch screen provided by the embodiment of the present invention, each shielding electrode is applied with a reverse signal opposite to a coupling signal coupled from the corresponding overlapped data line.

In a possible implementing mode, in the above in-cell touch screen provided by the embodiment of the present invention, the respective shielding electrodes overlapping with the same self-capacitance electrode are connected with one another.

In a possible implementing mode, in the above in-cell touch screen provided by the embodiment of the present invention, the respective shielding electrodes within the same touch scanning area are connected with one another.

In a possible implementing mode, in the above in-cell touch screen provided by the embodiment of the present invention, the shielding electrodes are arranged in the same layer as a pixel electrode layer located between the common electrode layer and the layer where the data lines locate.

The embodiment of the present invention provides a display device comprising the above in-cell touch screen provided by the embodiment of the present invention.

The beneficial effects of the embodiment of the present invention include:

The in-cell touch screen and the display device provided by the embodiment of the present invention multiplex a common electrode layer on the array substrate as self-capacitance electrodes. The common electrode layer comprises a plurality of self-capacitance electrodes arranged in array, and the common electrode layer is divided into a plurality of adjacent touch scanning areas, each touch scanning area comprises at least one row of self-capacitance electrodes. In this way, when the gate lines within one of the plurality of touch scanning areas are scanned row by row, the self-capacitance electrodes within the one touch scanning area are applied with common electrode signals, and the self-capacitance electrodes in other touch scanning areas of the plurality of touch scanning areas are applied with touch detection signals. That is to say, when display is performed in one touch scanning area, touch driving is performed in other touch scanning areas. By means of the above driving manner, the aim of simultaneous display and touch control can be achieved. It can be ensured that the various display problems and touch problems would not be caused by insufficient time due to time division driving when performing high resolution display.

### BRIEF DESCRIPTION OF DRAWINGS

FIG. 1 is a timing diagram of an in-cell touch screen in the prior art;

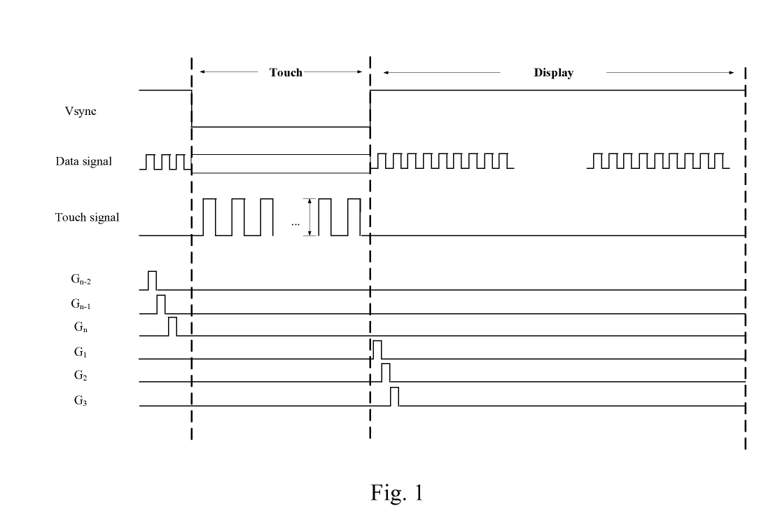

FIG. 2 is a schematic view of structure of an in-cell touch screen provided by the embodiment of the present invention;

FIG. 3 is a timing diagram of an in-cell touch screen provided by the embodiment of the present invention;

FIG. 4a-FIG. 4c are respectively schematic views of structure of a shielding electrode in an in-cell touch screen provided by the embodiment of the present invention;

FIG. 5 is a signal timing diagram of a shielding electrode in an in-cell touch screen provided by the embodiment of the present invention.

### DETAILED DESCRIPTION OF THE INVENTION

Next, the specific implementing modes of the in-cell touch screen and the display device provided by the embodiment of the present invention will be explained in detail with reference to the drawings.

The thickness and shape of the films in the drawings do not reflect the real proportion, which only aims to schematically explaining the contents of the present invention.

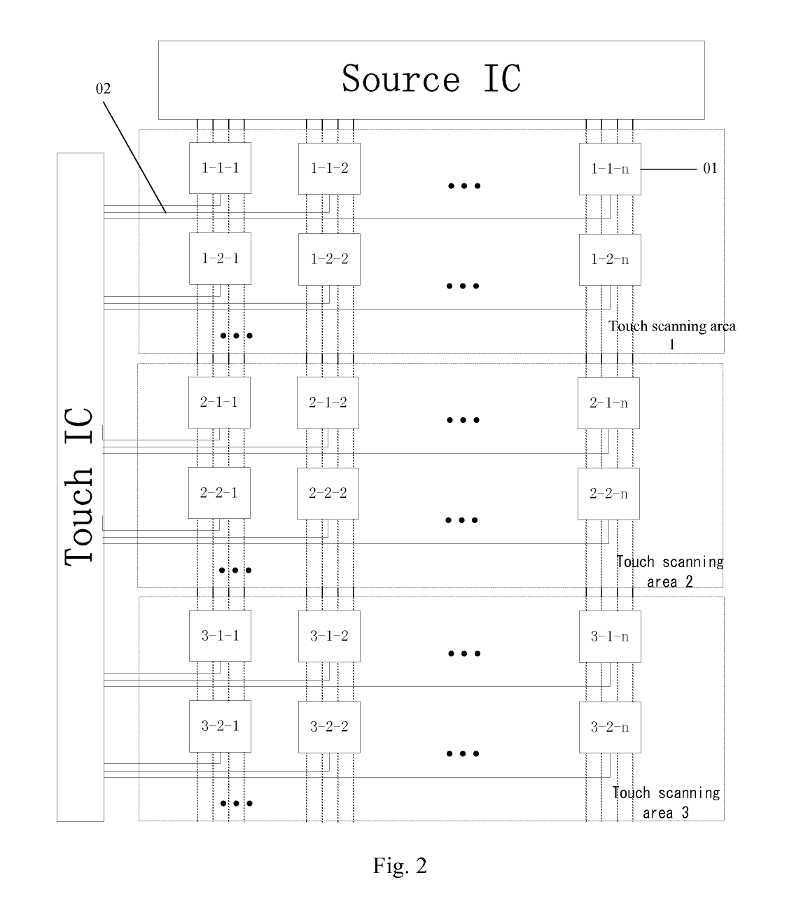

The embodiment of the present invention provides an in-cell touch screen, comprising: an array substrate having gate lines, data lines and a common electrode layer. The vertical view of the array substrate is as shown in FIG. 2. The common electrode layer comprises a plurality of self-capacitance electrodes 01 arranged in array. The common electrode layer is divided into a plurality of adjacent touch scanning areas, each touch scanning area comprises at least one row of self-capacitance electrodes. FIG. 2 takes three touch scanning areas as an example for explanation.

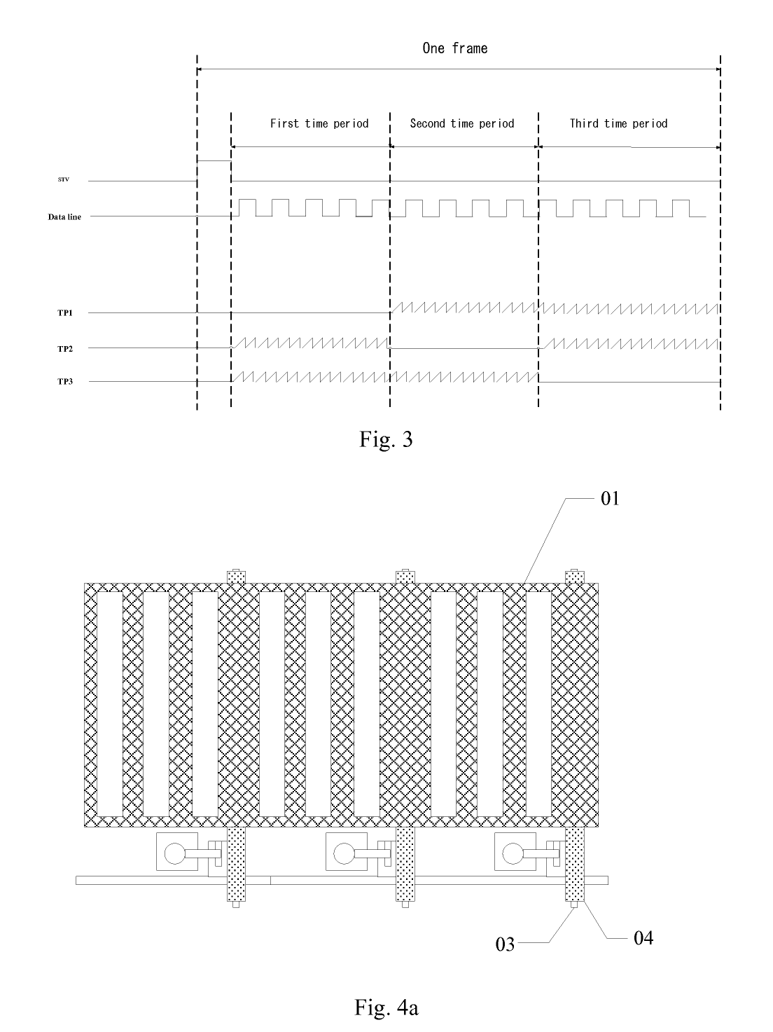

As shown in FIG. 3, when the gate lines within one of the plurality of touch scanning areas are scanned row by row, the self-capacitance electrodes TP1, TP2 and TP3 within the one touch scanning area are applied with common electrode signals (denoted by straight lines in FIG. 3); and the self-capacitance electrodes TP1, TP2 and TP3 in other touch scanning areas of the plurality of touch scanning areas except for this touch scanning area are applied with touch detection signals (denoted by zigzag lines in FIG. 3).

The above in-cell touch screen provided by the embodiment of the present invention multiplexes the common electrode layer on the array substrate as self-capacitance electrodes. The common electrode layer comprises a plurality of self-capacitance electrodes arranged in array. The common electrode layer is divided into a plurality of adjacent touch scanning areas, each touch scanning area comprises at least one row of self-capacitance electrodes, for example, being divided into three touch scanning areas as shown in FIG. 2. In this way, in the first time period of one frame, when the gate lines within the first touch scanning area are scanned row by row, the respective self-capacitance electrodes within the second and third touch scanning areas perform touch scanning, the respective self-capacitance electrodes within the first touch scanning area are used as common electrodes. By parity of reasoning, in the second time period of one frame, when the gate lines within the second touch scanning area are scanned row by row, the respective self-capacitance electrodes within the first and third touch scanning areas perform touch scanning, the respective self-capacitance electrodes within the second touch scanning area are used as common electrodes. In the third time period of one frame, when the gate lines within the third touch scanning area are scanned row by row, the respective self-capacitance electrodes within the first and second touch scanning areas perform touch scanning, the respective self-capacitance electrodes within the third touch scanning area are used as common electrodes. Thus it is ensured that within the time of one frame, each touch scanning area of the three touch scanning areas in the whole panel are scanned once according to display driving, and each touch scanning area are scanned twice according to touch driving, so that the scanning frequency of the touch driving can be two times of the scanning frequency of the display driving. For example, the display driving performs scanning with a frequency of 60 Hz, the touch driving can achieve a frequency of 120 Hz, thereby meeting the requirement of the general touch driving (80 Hz-120 Hz).

From the above analysis it can be seen that in the above in-cell touch screen provided by the embodiment of the present invention, the self-capacitance electrodes can be divided into different areas based on the actual requirement of the scanning frequency of the touch driving. That is to say, if it is required that the scanning frequency of the touch driving is N times of the scanning frequency of the display driving, it can be achieved by dividing the self-capacitance electrodes into N+1 areas. It should be noted that when the self-capacitance electrodes are divided, the row number of the self-capacitance electrodes contained in each touch scanning area is set substantially the same, thus it will be convenient for control of the scanning.

Generally, the touch density of the touch screen is generally at millimeter scale. Hence, in specific implementation, the density and the occupied area of respective self-capacitance electrodes 01 can be selected based on the required touch density so as to ensure the required touch density. Generally, the respective self-capacitance electrodes 01 are designed as square electrodes about 5 mm*5 mm. Whereas the display density of the display screen is generally at micron scale. Hence, one self-capacitance electrode 01 may correspond to a plurality of pixel units in the display screen generally, i.e., one self-capacitance electrode 01 may cover a plurality of gate lines and data lines.

On the basis of this, in the above touch screen provided by the embodiment of the present invention, in order to avoid the signals on the gate lines overlapping with the self-capacitance electrode from interfering it when it performs touch driving, the touch detection chip (Touch IC) arranged on the array substrate for determining the touch position by detecting the variation of the capacitance values of the self-capacitance electrode can be arranged at the left side or the right side of the array substrate, as shown in FIG. 2. The touch detection chip (Touch IC) can be arranged at the same side as the driving circuit of the gate lines, further, the two can also be integrated within the same chip. The respective self-capacitance electrodes 01 within the touch scanning area are connected with the touch detection chip respectively through wiring 02. The extending direction of the wiring 02 is same as the extending direction of the gate lines. In this way, when the gate lines do not perform display driving, the self-capacitance electrodes 01 perform touch driving, the wiring 02 connected with them are applied with touch signals, which would not be influenced by the display driving signals of the gate lines. When the gate lines perform display driving, the self-capacitance electrodes 01 are applied with common electrode signals, and also perform display driving while being unrelated to the touch driving.

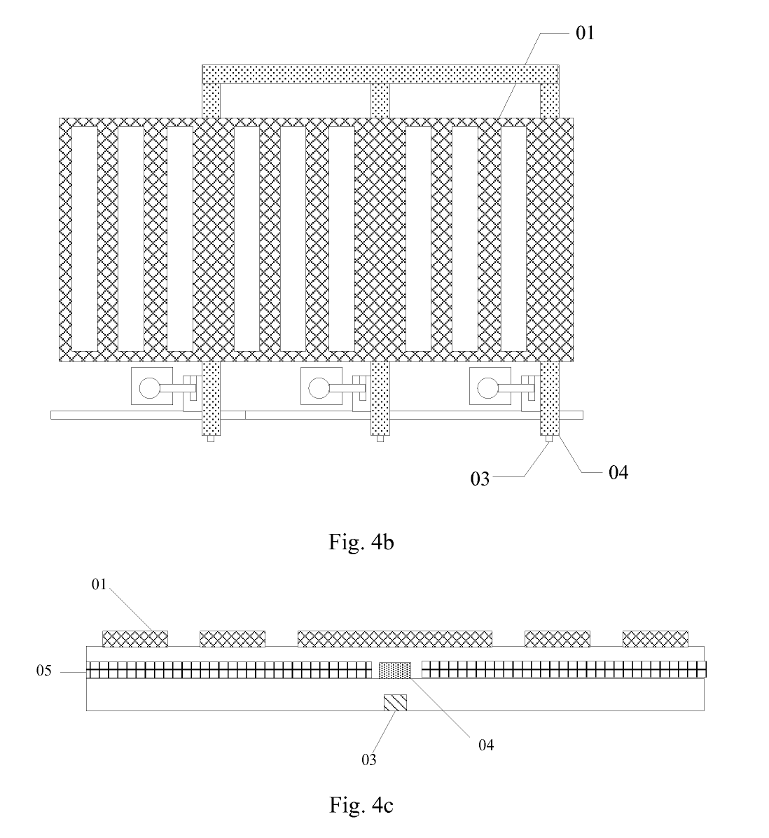

From the above analysis it can be seen that the above wiring manner can avoid the signals applied on the gate lines from interfering the touch signals. However, since the data lines and the gate lines are perpendicular to each other, hence, it cannot avoid the the signals applied on the data lines from interfering the touch signals. Therefore, in the above touch screen provided by the embodiment of the present invention, as shown in FIG. 4a, FIG. 4b and FIG. 4c, generally within the touch scanning area, shielding electrodes 04 located between the respective self-capacitance electrodes 01 and the layer where the data lines 03 locate is arranged. The orthogonal projection of the shielding electrodes 04 on the array substrate shields the overlapping area of the self-capacitance electrodes 01 and the data lines 03. That is, the shielding electrodes 04 are arranged between the common electrode layer and the layer where the data lines 03 locate, and shield the data lines 03. The shape of the shielding electrodes 04 is generally slightly wider than the data lines 03.

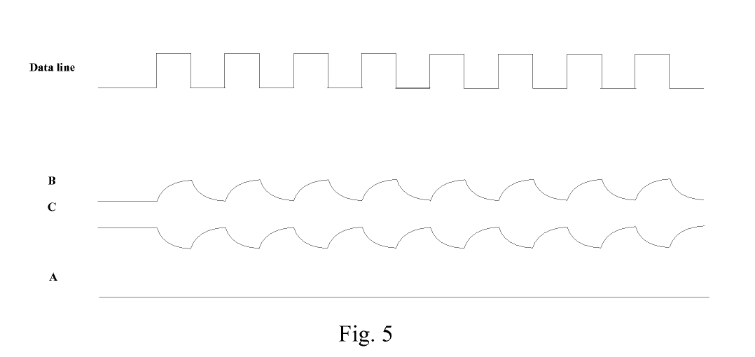

In order to enable the shielding electrodes to shield the signal interference of the data lines to the self-capacitance electrodes, in specific implementation, as shown in FIG. 5, a DC signal A can be applied on the shielding electrodes 04; or an AC signal can also be applied on the shielding electrodes 04, e.g., a reverse signal C opposite to a coupling signal B coupled from the corresponding overlapped data line.

In actual design, one self-capacitance electrode 01 may over a plurality of data lines 03 generally. It has to arrange a corresponding shielding electrode 04 for each data line 03, can it avoid the data signal from interfering the touch signal. Hence, there will be relatively more wirings to which the shielding electrodes 04 correspond, which may occupy the aperture ratio of display. On the basis of this, in specific implementation, as shown in FIG. 4b, the respective shielding electrodes 04 overlapping with the same self-capacitance electrode 01 can be arranged to connect with one another. Thus, signal transmission can be realized only by arranging the same number of wirings to which the shielding electrodes 04 correspond as the self-capacitance electrodes 01, which saves the design space.

In specific implementation, the respective shielding electrodes within the same touch scanning area can be connected with one another. Thus, signal transmission can be realized only by arranging the same number of wirings to which the shielding electrodes 04 correspond as the touch scanning area, which saves the design space furthest and simplifies the signal transmission.

In the above touch screen provided by the embodiment of the present invention, shielding electrodes are needed to shield the interference of the signals applied on the data lines to the touch signals. In order not to increase new films as far as possible, and ensure the production efficiency and reduce the production cost, in specific implementation, as shown in FIG. 4c, the shielding electrodes 04 can be arranged in the same layer as the pixel electrode layer 05 located between the common electrode layer (self-capacitance electrodes 01) and the layer where the data lines 03 locate.

Based on the same inventive concept, the embodiment of the present invention further provides a display device comprising the above in-cell touch screen provided by the embodiment of the present invention. The display device may be any product or component with the display function such as a mobile phone, a tablet computer, a television, a display, a laptop, a digital photo frame, a navigator. The implementation of the display device may make reference to the embodiment of the above in-cell touch screen, which will not be repeated here.

The embodiment of the present invention provides an in-cell touch screen and a display device, which multiplex a common electrode layer on the array substrate as self-capacitance electrodes. The common electrode layer comprises a plurality of self-capacitance electrodes arranged in array, and the common electrode layer is divided into a plurality of adjacent touch scanning areas, each touch scanning area comprises at least one row of self-capacitance electrodes. In this way, when the gate lines within one of the plurality of touch scanning areas are scanned row by row, the self-capacitance electrodes within the one touch scanning area are applied with common electrode signals, and the self-capacitance electrodes in other touch scanning areas of the plurality of touch scanning areas are applied with touch detection signals. That is to say, when display is performed in one touch scanning area, touch driving is performed in other touch scanning area. By means of the above driving manner, the aim of simultaneous display and touch control can be achieved. It can be ensured that the various display problems and touch problems would not be caused by insufficient time due to time division driving when performing high resolution display.

Apparently, the skilled person in the art can make various modifications and variations to the present invention without departing from the spirit and scope of the present invention. In this way, provided that these modifications and variations of the present invention belong to the scope of the claims of the present invention and the equivalent technologies thereof, the present invention also intends to contain these modifications and variations.

1. An in-cell touch screen, comprising: an array substrate having gate lines, data lines and a common electrode layer wherein:
the common electrode layer comprises a plurality of self-capacitance electrodes arranged in array;
the common electrode layer is divided into a plurality of adjacent touch scanning areas, each touch scanning area comprises at least one row of self-capacitance electrodes;
when the gate lines within one of the plurality of touch scanning areas are scanned row by row, the self-capacitance electrodes within the one touch scanning area are applied with common electrode signals, and the self-capacitance electrodes in other touch scanning areas of the plurality of touch scanning areas are applied with touch detection signals.

2. The in-cell touch screen as claimed in claim 1, further comprising: a touch detection chip arranged on the array substrate for determining the touch position by detecting variation of capacitance values of the self-capacitance electrodes;
the touch detection chip is located at the left side or the right side of the array substrate;
the self-capacitance electrodes within the plurality of touch scanning areas are connected with the touch detection chip through wiring respectively, the extending direction of the wiring is same as the extending direction of the gate lines.

3. The in-cell touch screen as claimed in claim 1, wherein within the plurality of touch scanning areas, shielding electrodes located between the self-capacitance electrodes and the layer where the data lines locate are arranged, an orthogonal projection of the shielding electrodes on the array substrate shields an overlapping area of the self-capacitance electrodes and the data lines.

4. The in-cell touch screen as claimed in claim 3, wherein the shielding electrodes are arranged in the same layer as a pixel electrode layer located between the common electrode layer and the layer where the data lines locate.

5. The in-cell touch screen as claimed in claim 3, wherein the shielding electrodes are applied with DC signals.

6. The in-cell touch screen as claimed in claim 5, wherein the shielding electrodes are arranged in the same layer as a pixel electrode layer located between the common electrode layer and the layer where the data lines locate.

7. The in-cell touch screen as claimed in claim 3, wherein each shielding electrode is applied with a reverse signal opposite to coupling signal coupled from the corresponding overlapped data line.

8. The in-cell touch screen as claimed in claim 7, wherein the shielding electrodes are arranged in the same layer as a pixel electrode layer located between the common electrode layer and the layer where the data lines locate.

9. The in-cell touch screen as claimed in claim 3, wherein the shielding electrodes overlapping with the same self-capacitance electrode are connected with one another.

10. The in-cell touch screen as claimed in claim 9, wherein the shielding electrodes are arranged in the same layer as a pixel electrode layer located between the common electrode layer and the layer where the data lines locate.

11. The in-cell touch screen as claimed in claim 9, wherein the shielding electrodes within the same touch scanning area are connected with one another.

12. The in-cell touch screen as claimed in claim 11, wherein the shielding electrodes are arranged in the same layer as a pixel electrode layer located between the common electrode layer and the layer where the data lines locate.

13. A display device, wherein, comprising an in-cell touch screen, wherein the in-cell touch screen comprises:
an array substrate having gate lines, data lines and a common electrode layer, wherein:
the common electrode layer comprises a plurality of self-capacitance electrodes arranged in an array;
the common electrode layer is divided into a plurality of adjacent touch scanning areas, each touch scanning area comprises at least one row of self-capacitance electrodes;
when the gate lines within one of the plurality of touch scanning areas are scanned row by row, the self-capacitance electrodes within the one touch scanning area are applied with common electrode signals, and the self-capacitance electrodes in other touch scanning areas of the plurality of touch scanning areas are applied with touch detection signals.

14. The display device as claimed in claim 13, wherein, the in-cell touch screen further comprising: a touch detection chip arranged on the array substrate for determining the touch position by detecting variation of capacitance values of the self-capacitance electrodes;
the touch detection chip is located at the left side or the right side of the array substrate;
the self-capacitance electrodes within the plurality of touch scanning areas are connected with the touch detection chip through wiring respectively, the extending direction of the wiring is same as the extending direction of the gate lines.

15. The display device as claimed in claim 13, wherein within the plurality of touch scanning areas, shielding electrodes located between the self-capacitance electrodes and the layer where the data lines locate are arranged, an orthogonal projection of the shielding electrodes on the array substrate shields an overlapping area of the self-capacitance electrodes and the data lines.

16. The display device as claimed in claim 15, wherein the shielding electrodes are applied with DC signals.

17. The display device as claimed in claim 15, wherein each shielding electrode is applied with a reverse signal opposite to a coupling signal coupled from the corresponding overlapped data line.

18. The display device as claimed in claim 15, wherein the shielding electrodes overlapping with the same self-capacitance electrode are connected with one another.

19. The display device as claimed in claim 18, wherein the shielding electrodes within the same touch scanning area are connected with one another.

20. The display device as claimed in claim 15, wherein the shielding electrodes are arranged in the same layer as a pixel electrode layer located between the common electrode layer and the layer where the data lines are located.
